(19) United States
(12) Patent Application Publication
(10) Pub. No.: US 2005/0136255 A1
(43) Pub. Date: Jun. 23, 2005

(54) High-strength abrasion-resistant monofilament yarn and sleeves formed therefrom

(75) Inventors: Harry F. Gladfelter, Kimberton, PA (US); Richard J. Sherman, Elverson, PA (US)

Correspondence Address: SYNNESTVEDT & LECHNER, LLP, 2600 ARAMARK TOWER, 1101 MARKET STREET, PHILADELPHIA, PA, 191072950, US

(73) Assignee: Federal-Mogul World Wide, Inc., Southfield, MI (US)

(21) Appl. No.: 11/012,535

(22) Filed: Dec. 15, 2004

Related U.S. Application Data
(60) Provisional application No. 60/529,720, filed on Dec. 15, 2003.

(51) Int. Cl. B32B 1/08

(52) U.S. Cl. 428/375; 428/36.1

(57) ABSTRACT

A filamentary member and a sleeve made therewith are disclosed. The filamentary member has an inner core formed of a material with a high tensile strength. The core is surrounded by an outer sheath formed of an abrasion resistant material. The filamentary member is formed by co-extruding the core and the sheath together through a spinnerette having coaxial nozzles. When spun from a molten state, the core and sheath fuse at the interface between them to provide transverse shear continuity. The sleeve may be woven, knitted or braided using the filamentary members and has the characteristics of abrasion resistance and high tensile strength without the need for separate yarns having these characteristics.

### FIELD OF THE INVENTION

This invention concerns monofilament yarns formed from different materials combined to provide high strength and abrasion resistance.

### BACKGROUND OF THE INVENTION

It is often desirable to have yarns with combinations of properties that are not normally present in a single yarn formed of a single material. For example, a sleeve for protecting elongated items such as wiring harnesses or optical fibers should have both adequate tensile strength as well as abrasion resistance. These characteristics are desirable due to the nature of the use of the sleeve, which, when deployed for use, is drawn over considerable distances through narrow, crowded ducts and over and around obstacles and the like. The drawing process places high tensile loads on the sleeve and induces in it significant stress, hence the need for relatively high tensile strength. Contact with the duct sidewalls (especially at 90° bends in the duct), as well as other sleeves and objects within the duct induce frictional forces on the sleeve which causes heating and abrasion, hence the desire for abrasion resistance.

Other protective sleeves may require abrasion resistant yarns that have relatively high resilience in order to provide radially oriented biasing forces that keep the sleeve in an open configuration. The abrasion resistance protects the sleeve from vibration induced wear, as might occur with sleeves used to protect wiring harnesses in an automobile or an aircraft.

In the past, it was the practice to form such sleeves from different types of yarns made from different materials having the desired characteristics. For example, a sleeve would be woven from aramid or polyester yarns to provide high tensile strength, and lower strength nylon yarns would be interwoven with the high strength yarns to provide abrasion resistance. The nylon yarns would have a greater diameter than the aramid or polyester yarns so as to form an outwardly extending contact surface of nylon that would protect the higher strength yarns from abrasion. However, such sleeves are relatively expensive to manufacture due to the need for different yarns.

### SUMMARY OF THE INVENTION

The invention concerns a filamentary member comprising an elongated inner core formed of a first material and an elongated outer sheath surrounding the inner core. The outer sheath is formed of a second material. The first material has a higher tensile strength than the second material, said second material has a greater abrasion resistance than the first material.

Preferably, the first material is polyester and comprises about 70 wt % of the filamentary member, and the second material is nylon and comprises about 30 wt % of the filamentary member. The filamentary members have a minimum diameter of 0.006 inches and may range in diameter between 0.006 inches and 0.015 inches.

The invention also includes tubular sleeves made from the aforementioned filamentary members. The sleeves may be woven, knitted or braided.

### BRIEF DESCRIPTION OF THE DRAWINGS

FIG. 1 is a cross-sectional view of a filamentary member according to the invention;

FIG. 2 is a longitudinal sectional view of a spinnerette used in manufacturing the filamentary member shown in FIG. 1;

FIG. 3 is a perspective view of an exemplary sleeve structure made of filamentary members according to the invention;

FIG. 4 is a perspective view of a plurality of sleeves within a duct;

FIG. 5 is a perspective view of a sleeve assembly comprising sleeves according to the invention;

FIG. 6 is a cross-sectional view taken at line 6-6 of FIG. 5; and

FIGS. 7 and 8 are perspective views of further examples of sleeves manufactured using filamentary members according to the invention.

### DETAILED DESCRIPTION OF EMBODIMENTS

FIG. 1 shows a cross-sectional view of a filamentary member 10 according to the invention. Filamentary member 10 is a monofilament having a core 12 surrounded by a sheath 14. Preferably, core 12 is a polyester such as PET and sheath 14 is a nylon or amide polymer such as nylon 6, nylon 66 and nylon 610. The polyester core 12 provides the desired tensile strength and resilience to the monofilament 10, and the nylon sheath 14, surrounding core 12, provides the abrasion resistance.

Other high-strength polymer materials, such as PPS and PEEK, are also feasible for forming core 12. Alternative materials for sheath 14 include PFA and PTFE.

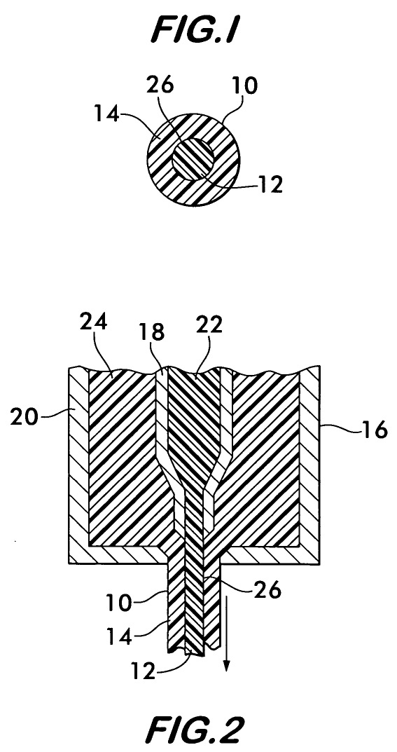

Monofilament 10 is preferably manufactured using a sheath/core extrusion process illustrated in FIG. 2. A spinnerette 16 is used having an inner nozzle 18 positioned within an outer nozzle 20. A material 22 comprising the core 12, in this example polyester, is extruded under pressure from the inner nozzle 18. Simultaneously, another material 24, the abrasion resistant nylon, for example, is extruded under pressure from the outer nozzle 20. The nozzles 18 and 20 are aligned so that the core 12 exits the spinnerette 16 surrounded by the sheath 14 to form the filamentary member 10.

The materials 24 and 22 forming the sheath 14 and core 12 are preferably compatible with one another such that, upon extrusion, the sheath and core fuse together at the interface 26 between them to provide transverse shear continuity to the filamentary member 10. Fusing of the sheath 14 to the core 12 is facilitated by the particular details of the extrusion process, which may, for example, be a melt extrusion wherein materials 22 and 24 are extruded in a molten state and fuse together in this state upon contact within the spinnerette 16.

Filamentary members 10 may be interlaced by weaving, braiding or knitting techniques to produce various types of sleeves for protecting elongated items from various harsh environments, particularly abrasion. Three examples of practical protective sleeves are presented below.

Flat Woven Sleeve

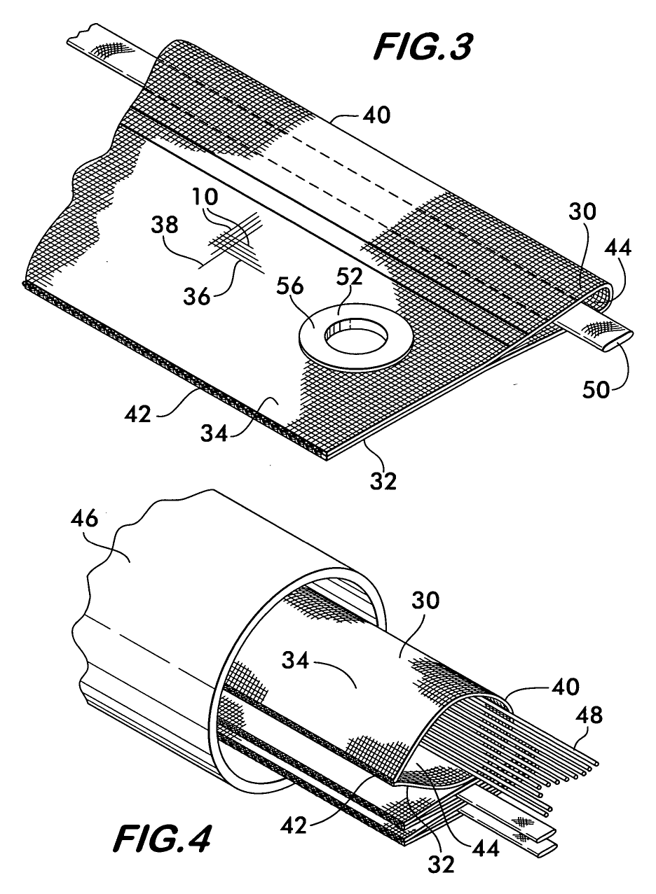

FIG. 3 shows an elongated sleeve 30 comprising opposed layers 32 and 34 of woven filamentary members 10 according to the invention. Filamentary members 10 include warp yarns 36 and fill yarns 38, the fill yarns being common to both layers 32 and 34. Preferably, the core 12 of filamentary member 10 is a polyester and the sheath 14 is nylon. Other candidate materials for the core include PPS and PEEK, and the sheath could also be made of PFA and PTFE.

Because the yarns have a high-strength inner core 12 and an abrasion-resistant outer sheath 14, the sleeve 30 is able to withstand both the tensile stresses imposed, as well as the friction between the sleeve and objects which it contacts while being drawn through a duct. The single filamentary member 10 combines both properties of tensile strength and abrasion resistance, thus the sleeve 30 may be woven simply and inexpensively using a single type of yarn for both warp and fill yarns 36 and 38. This contrasts with sleeves made from a combination of different yarns to provide multiple, and sometimes mutually exclusive characteristics such as high strength and abrasion resistance. The weaving of such sleeves is more complex and expensive than a sleeve 30 made from filamentary members 10 having a high-strength core 12 and an abrasion resistant outer sheath 14 according to the invention.

The opposed layers 32 and 34 may have a common seamless edge 40 and are joined to one another along a second edge 42 formed by various means. Preferably, as shown in FIG. 4, the opposed layers 32 and 34 are of equal width and surround and define a central space 44. The opposed layers 32 and 34 are nominally in a substantially flat, closely spaced relationship. This allows them to be easily drawn through a duct 46 as depicted in FIG. 4. As further shown in that Figure, opposed layers 32 and 34 are resiliently separable into a spaced apart relationship, in which relationship a plurality of elongated items 48, such as optical fiber cables or wire bundles may be accommodated within the central space 44. Preferably, the opposed layers 32 and 16 are resiliently biased to return to the substantially flat configuration in the absence of the elongated items 48.

In one preferred embodiment, both the warp and fill yarns 36 and 38 consist essentially of sheath and core filamentary members 10 and are interwoven using a weave pattern characterized by “floats” of either warp or fill yarns on the surface of the woven layers. A yarn is said to “float” when it is not interwoven alternately with each cross yarn but skips two or more cross yarns before being interwoven. Weaves using floats include twill, satin and sateen weaves. In twill and satin weaves, the warp yarns float over the fill yarns, whereas in the sateen weave, the fill yarns float over the warp yarns. Satin weaves are characterized by having longer floats than twills. In general twill, satin and sateen weaves are favored because they provide a durable fabric which resists wear and abrasion and provides a smooth surface with low friction. However, plain weaves are perfectly satisfactory for many applications. The floats are preferably positioned on the inner surface of the sleeves. This allows elongated items 48 to be drawn more easily through the central space 44 when such items are being installed within the sleeve 30. The flat configuration of the sleeve also provides advantage when it is drawn through a duct, as it maintains a low profile, allowing the sleeve to more readily traverse crowded ducts and sharp curves in comparison with a sleeve that is normally biased into an open configuration.

In a particular embodiment using sheath and core warp and fill yarns, the warp yarns have a diameter from about 0.006 to about 0.015 inches, the fill yarns have a diameter from about 0.006 to about 0.015 inches, and the sleeve 30 has a weave density of 25 to 75 ends per inch by 20 to 60 picks per inch. The weave density depends upon the sizes of the warp and fill yarns comprising the sleeve. Preferably, the core comprises about 70 wt % of the filamentary member and the sheath comprises about 30 wt %.

As shown in FIG. 3, sleeve 30 also includes a pull tape 50 arranged within the central space 44 between the opposed layers 32 and 34. The pull tape 50 extends the length of the sleeve 30 and facilitates the installation of elongated items. Once the sleeve is positioned within a duct, the elongated item is attached to one end of the pull tape 50 and the other end is drawn through the sleeve, the elongated item replacing the pull tape within the sleeve. Note that the use of yarns 36 and 38 having an abrasion resistant outer surface facilitates drawing of the elongated item through the sleeve 30, as well as drawing of the sleeve through the duct. Preferably, pull tape 50 has a flat cross-sectional profile to reduce the bulk of the sleeve. The pull tape 50 may be woven, braided or otherwise interlaced from high strength fibers such as aramids which will withstand significant tensile loads during the pulling operation. Pull tapes having a tensile capability between 300 lbs and 2,600 lbs tension force are considered feasible with the invention.

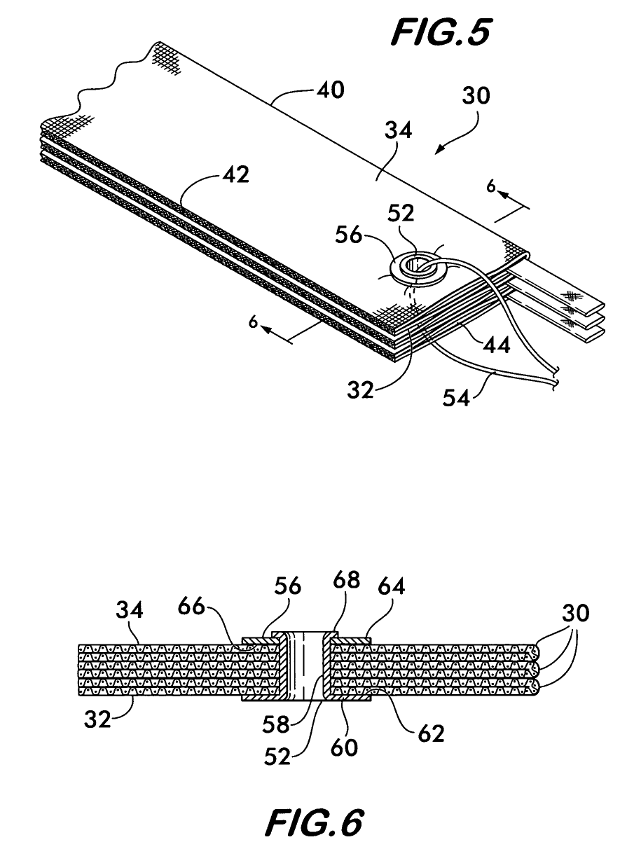

As shown in FIG. 3, the sleeve 30 includes an attachment piece 52. Attachment piece 52 may take one of several embodiments and serves to attach multiple sleeves 30 to one another in overlying relation to form an assembly as illustrated in FIG. 5. As further shown in the figure, the attachment piece 52 may also provide a location where a line 54 may be attached to draw one or more sleeves 30 through a duct.

As shown in FIGS. 3, 5 and 6, in a preferred embodiment of the sleeve 30, the attachment piece 52 comprises a grommet 56 located at one end of the sleeve 30. As shown in cross-section in FIG. 6, grommet 56 comprises a tube 58 that extends through one or more sleeves 30. A flange 60 is attached to one end of the tube 58. The flange 60 provides a surface 62 engageable with an opposed layer 32 of one of the sleeves 30 to retain the grommet to the sleeve. The grommet also comprises a ring 64 which receives tube 58 and is positionable in overlying relation with flange 60. Ring 64 provides a surface 66 engageable with another opposed layer 34, either on the same sleeve 30 or on another sleeve, in overlying relation with the first named sleeve to retain the grommet to the sleeve or assembly of sleeves. The ring 64 is retained by a lip 68 formed by outwardly reverse folding the tube in a cold-working process. Grommet 56 may be used on a single sleeve 30 as shown in FIG. 3, or as shown in FIG. 5, on a sleeve assembly to attach a plurality of sleeve structures to one another in overlying relationship. The grommet 56 enables single or multiple sleeves 30 to be drawn through a duct. After the sleeves are positioned within the duct, the grommet 56 is removed, preferably by severing the sleeves at or near the grommet.

Braided Sleeve

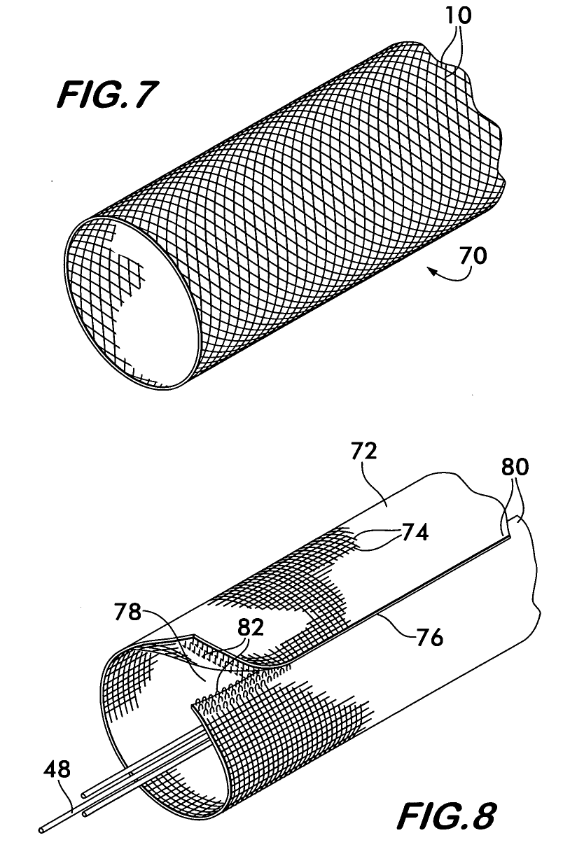

FIG. 7 shows a sleeve 70 formed by braiding filamentary members 10 having a high-strength, resilient core 12 and an abrasion resistant sheath 14 as shown in FIG. 1. Due to its combination of high tensile strength and abrasion resistance afforded by filamentary members 10, braided sleeves such as 70 may be advantageous for use as protective/reinforcing coverings for flexible hoses carrying pressurized fluids. The high strength of the filamentary members provide the hose with a high burst pressure while the abrasion resistance provides for a robust design capable of withstanding rough handling.

Braided sleeves made from filamentary members having a resilient core within an abrasion resistant sheath are also useful, for example, in automotive applications where a protective sleeve may be used to protect a wiring harness from abrasion caused by contact with the automobile structure due to engine or road vibration. The resilient qualities of the core provide a radially directed biasing force that keeps the braided sleeve in an open configuration.

Woven Biased Slit Sleeves

The combination of resilience and abrasion resistance is also useful in the manufacture of protective sleeves 72, shown in FIG. 8, that are biased into an open configuration by the resilience of the fill filaments 74. Sleeve 72 may have a lengthwise slit 76 providing an opening 78 that allows the sleeve 72 to be positioned around a wiring harness or other elongated item 48 for which the ends are inaccessible. The slit 76 also allows splices or breakouts to be conveniently formed at any point along the length of the sleeve.

Slit 76 may be closed by the resilience of the fill filaments 74 biasing the edges 80 into contact or overlying engagement, or closing means 82, such as hook and loop fasteners may be used to secure the slit closed but allow it to be conveniently opened as necessary for access to the elongated items therein. While the resilience of the core provides the biasing force to maintain the sleeve 72 in an open configuration with the edges 80 engaged so as to close the opening 78, the abrasion resistant sheath of the filamentary members protects the sleeve and its contents from damage due to vibration or motion induced friction.

Filamentary members having a high-strength resilient core surrounded by an abrasion resistant sheath combine desirable and mutually exclusive characteristics in a single filamentary member and thus allow protective sleeves also having these characteristics to be made simply and inexpensively.

1. A filamentary member comprising an elongated inner core formed of a first material, and an elongated outer sheath surrounding said inner core and formed of a second material, said first material having a higher tensile strength than said second material, said second material having a greater abrasion resistance than said first material.

2. A filamentary member according to claim 1, wherein said outer sheath is heat fused to said inner core.

3. A filamentary member according to claim 2, wherein said first material comprises polyester and said second material comprises nylon.

4. A filamentary member according to claim 3, wherein said nylon comprises about 30 wt % of said filamentary member and said polyester comprises about 70 wt % of said filamentary member.

5. A filamentary member according to claim 1, wherein said first material is selected from the group consisting of PET, PPS, PEEK and PBTU.

6. A filamentary member according to claim 1, wherein said second material is selected from the group consisting of nylon, PFA and PTFE.

7. A filamentary member according to claim 1, having a diameter no less than 0.006 inches.

8. A filamentary member according to claim 7, wherein said core has a diameter between 0.006 and 0.015 inches.

9. An elongated sleeve formed of interlaced filamentary members, at least a portion of said filamentary members comprising an elongated inner core formed of a first material, and an elongated outer sheath surrounding said inner core and formed of a second material, said first material having a higher tensile strength than said second material, said second material having a greater abrasion resistance than said first material.

10. A sleeve according to claim 9, wherein said filamentary members comprising said portion have a diameter no less than 0.006 inches.

11. A sleeve according to claim 10, wherein said cores of said filamentary members comprising said portion have a diameter between 0.006 and 0.015 inches.

12. A sleeve according to claim 9, wherein said filamentary members are interlaced by a method selected from the group consisting of weaving, knitting and braiding.
